(19) United States
(12) Patent Application Publication
(10) Pub. No.: US 2023/0370289 A1
(43) Pub. Date: Nov. 16, 2023

(54) PHYSICAL UNCLONABLE FUNCTION DEVICE, AND SIGNAL PROCESSING DEVICE AND IMAGE DISPLAY DEVICE HAVING SAME

(71) Applicant: LG ELECTRONICS INC., Seoul (KR)

(72) Inventors: Sungwoon MOON, Seoul (KR); Seungyup JANG, Seoul (KR); Sungwook HWANG, Seoul (KR)

(73) Assignee: LG ELECTRONICS INC., Seoul (KR)

(21) Appl. No.: 18/030,475

(22) PCT Filed: Aug. 24, 2021
(86) PCT No.: PCT/KR2021/011274

§ 371 Date: Apr. 5, 2023

(30) Foreign Application Priority Data
Oct. 5, 2020 (KR) 10-2020-0127988

(51) Int. Cl. H04L 9/32

(52) U.S. Cl. CPC H04L 9/3278

(57) ABSTRACT

A physical unclonable function device according to an embodiment of the present invention comprises: a bias circuit for outputting a first signal on the basis of a first operating power; a power source for outputting a second operating power on the basis of the first signal and the first operating power; and a plurality of inverters for performing an amplification operation on the basis of the second operating power from the power source. Accordingly, a physical unclonable function device which is robust to changes in operating power and reduces bit errors can be implemented.

### BACKGROUND

### 1. Field

The present disclosure relates to a physically unclonable function device, and a signal processing device and an image display apparatus including the same, and more particularly to a physically unclonable function device that is robust to operating power change and reduces bit errors, and a signal processing device and an image display apparatus including the physically unclonable function device.

### 2. Description of the Related Art

A physically unclonable function (PUF) is a technology for generating secure keys with unclonable unique chips based on mismatch between circuit elements in a semiconductor manufacturing process.

However, if a bit error occurs with different results in case in which an external environment, e.g., temperature, voltage, etc., changes, it is required to correct the error.

U.S. Pat. No. 9,966,954 (hereinafter referred to a related art) discloses a PUF circuit that outputs a random number by amplifying mismatch between a voltage generator and an amplification circuit.

However, the related art has a drawback in that in order to induce a sub-threshold region, it is required to use an element having a low threshold voltage (Vth), and the threshold voltage is reduced by using body bias, such that the effect is minimal in a FinFET process with low body effect.

In addition, the related art also has a drawback in that, with asymmetrical switching voltages and large operating power headroom, it is sensitive to operating power supplied from an external source, and a bit error therein increases.

### SUMMARY

It is an objective of the present disclosure to provide a physically unclonable function (PUF) device that is robust to operating power change and reduces bit errors, and a signal processing device and an image display apparatus including the PUF device.

It is another objective of the present disclosure to provide a PUF device in which headroom is reduced by using a current starved inverter, and bit errors are reduced by amplifying symmetric switching voltages, and a signal processing device and an image display apparatus including the PUF device.

It is further another objective of the present disclosure to provide a PUF device capable of outputting the same bit even in case in which an external environment changes, and a signal processing device and an image display apparatus including the PUF device.

According to an aspect of the present disclosure, a physically unclonable function (PUF) device according to an embodiment of the present disclosure, and a signal processing device and an image display apparatus including the same include: a bias circuit configured to output a first signal based on a first operating power; a power source configured to output a second operating power based on the first signal and the first operating power; and a plurality of inverters configured to perform an amplification operation based on the second operating power from the power source.

Meanwhile, the plurality of inverters may be sequentially arranged in a multi-stage, wherein a first inverter among the plurality of inverters may output a signal by bypassing an input signal, and inverters after the first inverter may output output signals by amplifying the input signal.

Meanwhile, the first inverter may include a current starved inverter.

Meanwhile, the power source may include a MOSFET device in which the first signal is input to a gate terminal, the first operating power is input to a source terminal, and the second operating power is output through a drain terminal.

Meanwhile, based on the first operating power, the bias circuit may supply the first signal having a current at a predetermined level or a voltage at a predetermined level.

Meanwhile, in case in which temperature changes or a level of the first operating power changes, a level of a first threshold voltage of the first inverter among the plurality of inverters may be greater than a level of a second threshold voltage of a second inverter among the plurality of inverters.

Meanwhile, the power source and the plurality of inverters may constitute one cell and may include the bias circuit and a plurality of cells.

Meanwhile, in response to the amplification operation, the plurality of inverters may generate and output random numbers.

Meanwhile, a physically unclonable function (PUF) device according to another embodiment of the present disclosure, and a signal processing device and an image display apparatus including the same include: a MOSFET device in which a first signal is input to a gate terminal, a first operating power is input to a source terminal, and a second operating power is output through a drain terminal; and a plurality of inverters configured to perform an amplification operation based on the second operating power from the MOSFET device, wherein the plurality of inverters are sequentially arranged in a multi-stage, wherein a first inverter among the plurality of inverters outputs a signal by bypassing an input signal, and inverters arranged in stages after the first inverter output signals by amplifying the input signal.

Meanwhile, even in case in which a level of the first operating power changes, a current or voltage of the first signal may be at a constant level.

Meanwhile, a physically unclonable function (PUF) device according to further another embodiment of the present disclosure, and a signal processing device and an image display apparatus including the same include: a plurality of cells arranged in a matrix form; a first decoder configured to supply a same signal to cells in a same row among the plurality of cells; a second decoder configured to supply a same signal to cells in a same column among the plurality of cells; and a bias circuit configured to output a first signal based on a first operating power, wherein each of the plurality of cells may include: a power source configured to output a second operating power based on the first signal and the first operating power; and a plurality of inverters configured to perform an amplification operation based on the second operating power from the power source.

### Effects of the Disclosure

A physically unclonable function (PUF) device, and a signal processing device and an image display apparatus including the same according to an embodiment of the present disclosure include: a bias circuit configured to output a first signal based on a first operating power; a power source configured to output a second operating power based on the first signal and the first operating power; and a plurality of inverters configured to perform an amplification operation based on the second operating power from the power source. Accordingly, a PUF device that is robust to operating power change and reduces bit errors may be implemented. In addition, a PUF device that is even robust to temperature change may be implemented. Particularly, a same bit may be output constantly even in case in which an external environment changes.

Meanwhile, the plurality of inverters may be sequentially arranged in a multi-stage, wherein a first inverter among the plurality of inverters may output a signal by bypassing an input signal, and inverters after the first inverter may output output signals by amplifying the input signal. Accordingly, the PUF device that is robust to operating power change and temperature change and reduces bit errors may be implemented.

Meanwhile, the first inverter may include a current starved inverter. Accordingly, the PUF device may be implemented in which headroom is reduced by using the current starved inverter, and bit errors are reduced by amplifying symmetric switching voltages.

Meanwhile, the power source may include a MOSFET device in which the first signal is input to a gate terminal, the first operating power is input to a source terminal, and the second operating power is output through a drain terminal. Accordingly, the PUF device that is robust to operating power change and temperature change and reduces bit errors may be implemented.

Meanwhile, based on the first operating power, the bias circuit may supply the first signal having a current at a predetermined level or a voltage at a predetermined level. Accordingly, the PUF device that is robust to operating power change and temperature change and reduces bit errors may be implemented.

Meanwhile, in case in which temperature changes or a level of the first operating power changes, a level of a first threshold voltage of the first inverter among the plurality of inverters may be greater than a level of a second threshold voltage of a second inverter among the plurality of inverters. Accordingly, the PUF device that is robust to operating power change and temperature change and reduces bit errors may be implemented.

Meanwhile, the power source and the plurality of inverters may constitute one cell and may include the bias circuit and a plurality of cells. Accordingly, a plurality of bits may be output.

Meanwhile, in response to the amplification operation, the plurality of inverters may generate and output random numbers. Accordingly, the PUF device that is robust to operating power change and temperature change and reduces bit errors may be implemented.

Meanwhile, a physically unclonable function (PUF) device according to another embodiment of the present disclosure, and a signal processing device and an image display apparatus including the same include: a MOSFET device in which a first signal is input to a gate terminal, a first operating power is input to a source terminal, and a second operating power is output through a drain terminal; and a plurality of inverters configured to perform an amplification operation based on the second operating power from the MOSFET device, wherein the plurality of inverters are sequentially arranged in a multi-stage, wherein a first inverter among the plurality of inverters outputs a signal by bypassing an input signal, and inverters arranged in stages after the first inverter output signals by amplifying the input signal. Accordingly, the PUF device that is robust to operating power change and reduces bit errors may be implemented. In addition, the PUF device that is even robust to temperature change may be implemented. Particularly, the same bit may be output constantly even in case in which the external environment changes.

Meanwhile, even in case in which a level of the first operating power changes, a current or voltage of the first signal may be at a constant level. Accordingly, the PUF device that is robust to operating power change and reduces bit errors may be implemented.

Meanwhile, a physically unclonable function (PUF) device according to further another embodiment of the present disclosure, and a signal processing device and an image display apparatus including the same include: a plurality of cells arranged in a matrix form; a first decoder configured to supply a same signal to cells in a same row among the plurality of cells; a second decoder configured to supply a same signal to cells in a same column among the plurality of cells; and a bias circuit configured to output a first signal based on a first operating power, wherein each of the plurality of cells may include: a power source configured to output a second operating power based on the first signal and the first operating power; and a plurality of inverters configured to perform an amplification operation based on the second operating power from the power source. Accordingly, the PUF device that is robust to operating power change and reduces bit errors may be implemented. In addition, the PUF device that is even robust to temperature change may be implemented. Particularly, the same bit may be output constantly even in case in which the external environment changes.

### BRIEF DESCRIPTION OF THE DRAWINGS

FIG. 1 is a diagram illustrating an image display apparatus according to an embodiment of the present disclosure.

FIG. 2 is an internal block diagram illustrating an image display apparatus of FIG. 1.

FIG. 3 is an internal block diagram illustrating a signal processing device of FIG. 2.

FIG. 4A illustrates a method for controlling a remote controller of FIG. 2.

FIG. 4B is an internal block diagram illustrating the remote controller of FIG. 2.

FIG. 5 is a diagram illustrating the appearance of a signal processing device according to an embodiment of the present disclosure.

FIGS. 6A and 6B are diagrams illustrating various examples of a PUF device associated with the present disclosure.

FIG. 7 is an example of a circuit diagram illustrating a PUF device according to an embodiment of the present disclosure.

FIGS. 8A to 16D are diagrams referred to in the description of FIG. 7.

### DETAILED DESCRIPTION OF THE PREFERRED EMBODIMENTS

Hereinafter, the present disclosure will be described in detail with reference to the accompanying drawings.

The suffixes “module” and “unit” for elements used in the present disclosure are given simply in view of the ease of the description, and do not have a distinguishing meaning or role. Therefore, the suffixes “module” and “unit” may be used interchangeably.

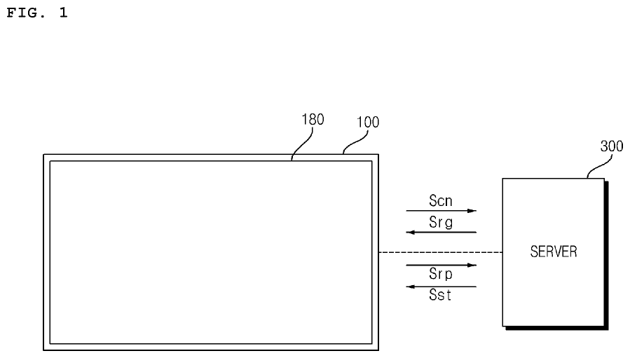

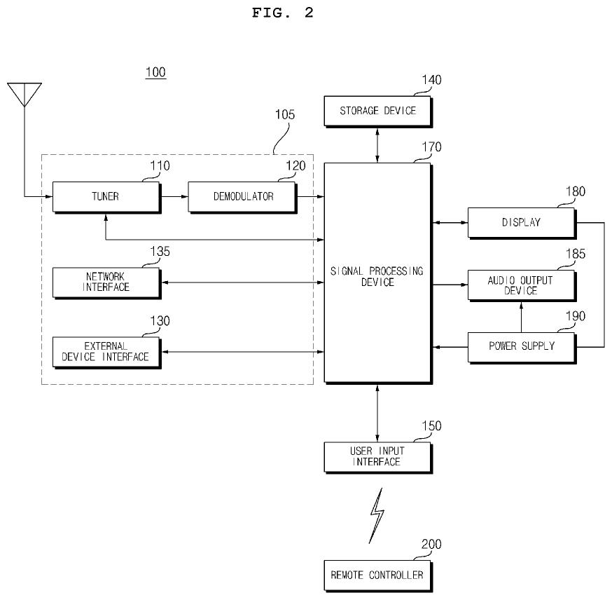

FIG. 1 is a diagram illustrating an image display apparatus according to an embodiment of the present disclosure.

Referring to the drawing, an image display apparatus 100 may include a display 180.

Meanwhile, the display 180 may be implemented as one of various panels. For example, the display 180 may be any one of a liquid crystal display (LCD) panel, an organic light emitting diode panel (OLED panel), an inorganic light emitting diode panel (LED panel), and the like.

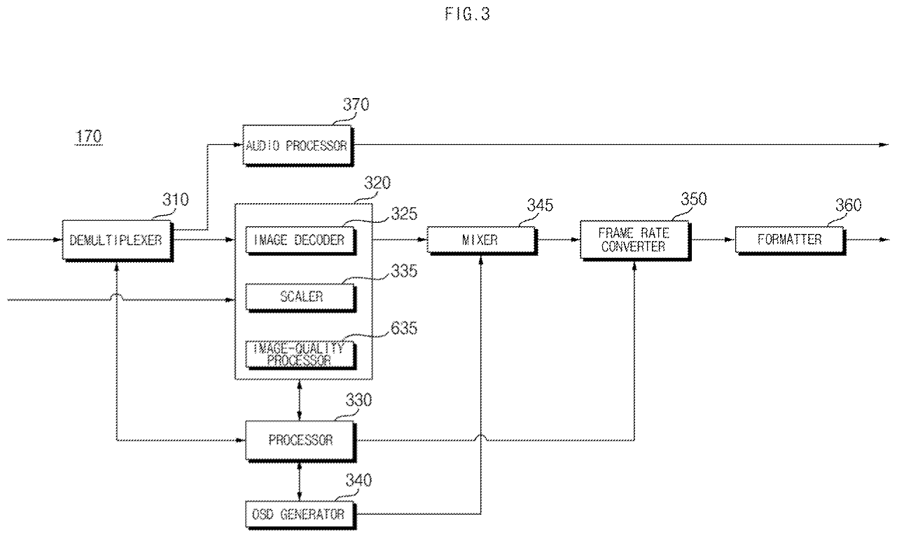

Meanwhile, the image display apparatus 10 may further include a signal processing device (170 of FIG. 2) configured to perform signal processing for image display on the display 180.

The signal processing device 170 may be implemented in the form of a system on chip (SOC).

Meanwhile, an external server 300 may transmit or stream predetermined information or video data to the image display apparatus 100.

For example, if the image display apparatus 100 is connected to the external server 300, the image display apparatus 100 may transmit an access request signal Scn to the external server 300, and the external server 300 may transmit an authentication request signal Srg to the image display apparatus 100.

In response, the image display apparatus 100 may transmit an encryption key data Srp to the external server 300, and in case in which authentication is completed by the external server 300 based on the encryption key data Srp, the image display apparatus 100 may transmit the access request signal Scn to the external server 300 and may transmit or stream predetermined information or video data Sst.

In this case, the encryption key data Srp is preferably data to which a physically unclonable function (PUF) based on hardware rather than software is applied, and thus cannot be duplicated.

Meanwhile, in case in which a PUF-based circuit is implemented, it is preferable to implement a PUF device that is robust to operating power change and reduces bit errors even in case in which external temperature or power voltage changes.

To this end, a PUF device 600 according to an embodiment of the present disclosure includes a bias circuit 710 configured to output a first signal S1 based on a first operating power VDD, a power source SWo configured to output a second operating power VVDD based on the first signal S1 and the first operating power VDD, and a plurality of inverters IVo to IVd configured to perform an amplification operation based on the second operating power VVDD from the power source SWo.

Accordingly, the PUF device 700 that is robust to operating power change and reduces bit errors may be implemented. In addition, the PUF device 700 that is even robust to temperature change may be implemented. Particularly, the same bit may be output constantly even in case in which the external environment changes.

Meanwhile, the image display apparatus 100 of FIG. 1 may be a TV receiver, a monitor, a tablet, a mobile terminal, a vehicle display device, a commercial display device, signage or the like.

FIG. 2 is an internal block diagram illustrating the image display apparatus of FIG. 1.

Referring to FIG. 2, the image display apparatus 100 according to one embodiment of the present disclosure may include an image receiver 105, an external device interface 130, a storage device 140, a user input interface 150, a sensor device (not shown), a signal processing device 170, a display 180, and an audio output device 185.

The image receiver 105 may include a tuner 110, a demodulator 120, a network interface 130, and an external device interface 130.

Meanwhile, unlike the drawing, the image receiver 105 may include only the tuner 110, the demodulator 120, the external device interface 130. That is, the network interface 130 may not be included.

The tuner 110 selects a channel selected by a user from among radio frequency (RF) broadcast signals received through an antenna (not illustrated) or an RF broadcast signal corresponding to all pre-stored channels. In addition, the tuner 110 converts the selected RF broadcast signal into a middle-frequency signal, a baseband image, or a voice signal.

For example, if the selected RF broadcast signal is a digital broadcast signal, it is converted into a digital IF signal (DIF). If the selected RF broadcast signal is an analog broadcast signal, it is converted into an analog baseband image or audio signal (CVBS/SIF). That is, the tuner 110 may process a digital broadcast signal or an analog broadcast signal. The analog baseband image or audio signal (CVBS/SIF) output from the tuner 110 may be directly input to the signal processing device 170.

Meanwhile, the tuner 110 can include a plurality of tuners for receiving broadcast signals of a plurality of channels. Alternatively, a single tuner that simultaneously receives broadcast signals of a plurality of channels is also available.

The demodulator 120 receives and demodulates a digital IF (DIF) signal converted by the tuner 110.

After performing demodulation and channel decoding, the demodulator 120 may output a stream signal (TS). Herein, the stream signal may be a signal obtained by multiplexing an image signal, voice signal or data signal.

The stream signal output from the demodulator 120 may be input to the signal processing device 170. After performing demultiplexing and image/voice signal processing, the signal processing device 170 outputs an image to the display 180 and voice to the audio output device 185.

The external device interface 130 may transmit or receive data to or from a connected external device (not illustrated), for example, a set-top box 50. To this end, the external interface 130 may include an A/V input/output device.

The external device interface 130 may be connected to external devices such as a digital versatile disc (DVD) player, a Blu-ray player, a gaming device, a camera, a camcorder, a computer (laptop), and a set-top box in a wired/wireless manner, and perform input/output operations with external devices.

The A/V input/output device may receive image and voice signals of the external device. Meanwhile, a wireless transceiver (not shown) may perform short-range wireless communication with other electronic devices.

The external device interface 130 may exchange data with a neighboring mobile terminal 600 via the wireless transceiver (not illustrated). In particular, in the mirroring mode, the external device interface 130 may receive device information, information about an executed application and an application image from the mobile terminal 600.

The network interface 135 provides an interface for connecting the image display apparatus to a wired/wireless network including the Internet. For example, the network interface 135 may receive content or data provided by the Internet or a content provider or network operator through a network.

The network interface 135 may include a wireless transceiver (not illustrated).

The storage device 140 may store programs for processing and control of signals in the signal processing device 170, and also store a signal-processed image, voice signal or data signal.

The storage device 140 may function to temporarily store an image signal, a voice signal, or a data signal input through the external device interface 130. In addition, the storage device 140 may store information about a predetermined broadcast channel through the channel memorization function such as a channel map.

While it is illustrated in FIG. 2 that the storage device 140 is provided separately from the signal processing device 170, embodiments of the present disclosure are not limited thereto. The storage device 140 may be included in the signal processing device 170.

The user input interface 150 may transmit a signal input by the user to the signal processing device 170 or transmit a signal from the signal processing device 170 to the user.

For example, the user input interface 150 may transmit/receive user input signals such as power on/off, channel selection, and screen setting to/from the remote controller 200, deliver user input signals input through local keys (not illustrated) such as a power key, a channel key, a volume key, or a setting key, deliver user input signals input through a sensor device (not illustrated) to sense user gestures to the signal processing device 170, or transmit a signal from the signal processing device 170 to the sensor device (not illustrated).

The signal processing device 170 may demultiplex streams input through the tuner 110, demodulator 120, network interface 135, or external device interface 130, or process demultiplexed signals. Thereby, the signal processing device 170 may generate an output signal for outputting an image or voice.

For example, the signal processing device 170 may receive a broadcast signal or HDMI signal received from the image receiver 105, perform signal processing based on the received broadcast signal or HDMI signal, and output the signal-processed image signal.

An image signal image-processed by the signal processing device 170 may be input to the display 180 and an image corresponding to the image signal may be displayed. In addition, the image signal which is image-processed by the signal processing device 170 may be input to an external output device through the external device interface 130.

A voice signal processed by the signal processing device 170 may be output to the audio output device 185 in the form of sound. In addition, the voice signal processed by the signal processing device 170 may be input to an external output device through the external device interface 130.

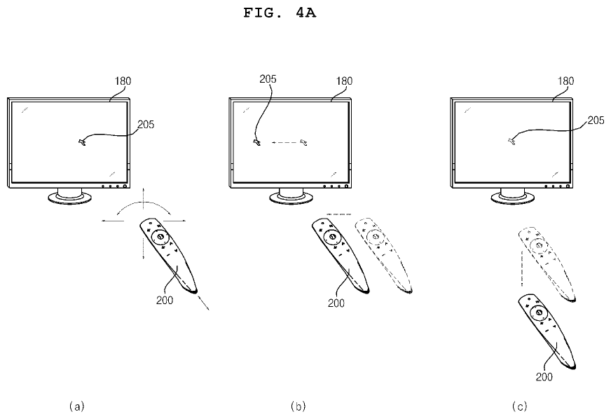

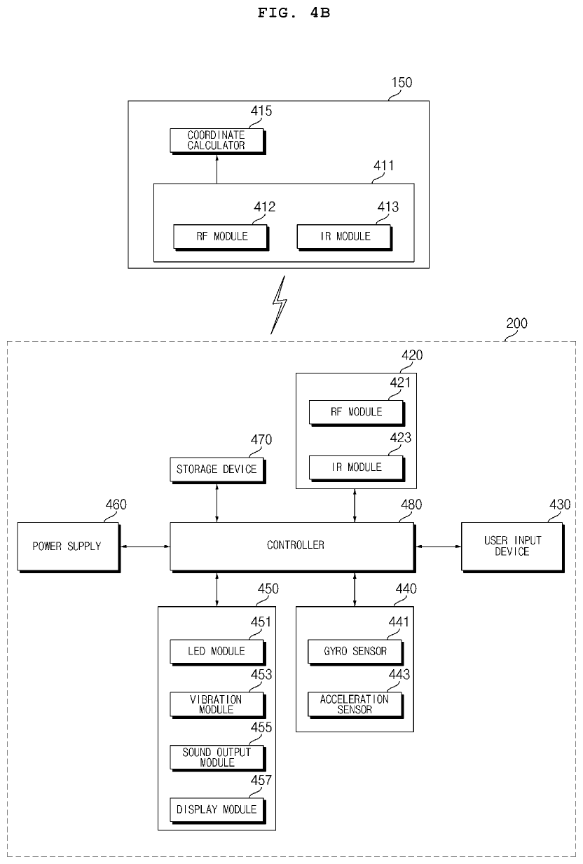

Although not illustrated in FIG. 2, the signal processing device 170 may include a demultiplexer, an image processor, and the like. That is, the signal processing device 170 may perform various signal processing, and thus may be implemented in the form of a System On Chip (SOC). This will be described later with reference to FIG. 3.

Additionally, the signal processing device 170 may control overall operation of the image display apparatus 100. For example, the signal processing device 170 may control the tuner 110 to tune to an RF broadcast corresponding to a channel selected by the user or a pre-stored channel.

The signal processing device 170 may control the image display apparatus 100 according to a user command input through the user input interface 150 or an internal program.

The signal processing device 170 may control the display 180 to display an image. Herein, the image displayed on the display 180 may be a still image, a moving image, a 2D image, or a 3D image.

The signal processing device 170 may be configured to display the predetermined object in an image displayed on the display 180. For example, the object may be at least one of an accessed web page (a newspaper, a magazine, or the like), electronic program guide (EPG), various menus, a widget, an icon, a still image, a moving image, or text.

The signal processing device 170 may recognize the location of the user based on an image captured by a capture device (not illustrated). For example, the signal processing device 170 may recognize a distance (a z-axis coordinate) between the user and the image display apparatus 100. Additionally, the signal processing device 170 may recognize an x-axis coordinate and a y-axis coordinate corresponding to the location of the user in the display 180.

The display 180 generates drive signals by converting an image signal, data signal, OSD signal, and control signal processed by the signal processing device 170 or an image signal, data signal, and control signal received from the external device interface 130.

The display 180 may be configured as a touch screen and used as an input device in addition to an output device.

The audio output device 185 receives a voice signal processed by the signal processing device 170 and outputs voice.

The capture device (not illustrated) captures the user. The capture device (not illustrated) may be implemented with one camera, but is not limited thereto, and may be implemented with a plurality of cameras. Image information captured by the capture device (not illustrated) may be input to the signal processing device 170.

The signal processing device 170 may sense user gestures based on an image captured by the capture device (not illustrated), a sensed signal from the sensor device (not illustrated), or a combination thereof.

The power supply 190 supplies corresponding power throughout the image display apparatus 100. In particular, the power supply 190 may supply power to the signal processing device 170 implemented in the form of a System On Chip (SOC), the display 180 for displaying images, an audio output device 185 for outputting audio, or the like.

Specifically, the power supply 190 may include a AC-DC converter to convert alternating current (AC) voltage into direct current (DC) voltage and a DC-DC converter to change the level of the DC voltage.

The remote controller 200 transmits user input to the user input interface 150. To this end, the remote controller 200 may employ Bluetooth, radio frequency (RF) communication, infrared (IR) communication, ultra-wideband (UWB), or ZigBee. In addition, the remote controller 200 may receive an image signal, a voice signal, or a data signal output from the user input interface 150, and display the signals on the remote controller 200 or voice-output.

The image display apparatus 100 may be a fixed or mobile digital broadcast receiver capable of receiving digital broadcast services.

The block diagram of the image display apparatus 100 illustrated in FIG. 2 is a block diagram for one embodiment of the present disclosure. Constituents of the block diagram may be integrated, added or omitted according to the specifications of the image display apparatus 100 which is implemented in reality. That is, two or more constituents may be combined into one constituent, or one constituent may be subdivided into two or more constituents, in case in which necessary. In addition, the function performed in each block is simply illustrative, and it should be noted that specific operations or devices of the blocks do not limit the scope of the present disclosure.

FIG. 3 is an internal block diagram illustrating the signal processing device of FIG. 2.

Referring to the drawings, the signal processing device 170 according to one embodiment of the present disclosure may include a demultiplexer 310, an image processor 320, a processor 330, and an audio processor 370. In addition, the signal processing device 170 may further include a data processor (not illustrated).

The demultiplexer 310 demultiplexes an input stream. For example, in case in which an MPEG-2 TS is input, the demultiplexer 310 may demultiplex the MPEG-2 TS to separate the MPEG-2 TS into an image signal, a voice signal and a data signal. Herein, the stream signal input to the demultiplexer 310 may be a stream signal output from the tuner 110, the demodulator 120 or the external device interface 130.

The image processor 320 may perform signal processing on an input image. For example, the image processor 320 may perform image processing of an image signal demultiplexed by the demultiplexer 310.

To this end, the image processor 320 includes an image decoder 325, a scaler 335, an image-quality processor 635, an image encoder (not illustrated), an OSD processor 340, a frame rate converter 350, and a formatter 360, and the like.

The image decoder 325 decodes the demultiplexed image signal, and the scaler 335 scales the resolution of the decoded image signal such that the image signal can be output through the display 180.

The image decoder 325 may include decoders of various standards. For example, the image decoder 325 may include an MPEG-2 decoder, an H.264 decoder, a 3D image decoder for color images and depth images, and a decoder for multi-viewpoint images.

The scaler 335 may scale an input image signal that has been image decoded by the image decoder 325 or the like.

For example, the scaler 335 may perform up-scaling in case in which the size or resolution of the input image signal is small, and down-scaling in case in which the size or resolution of the input image signal is large.

The image-quality processor 635 may perform image quality processing on an input image signal that has been image decoded in the image decoder 325 or the like.

For example, the image-quality processor 635 may perform noise removal processing of the input image signal, expand the resolution of gray levels of an input image signal, improve image resolution, perform high dynamic range (HDR) based signal processing, change the frame rate, or perform image quality processing corresponding to panel characteristics, particularly organic light emitting panels or the like.

The OSD processor 340 generates an OSD signal automatically or according to user input. For example, the OSD processor 340 may generate a signal for display of various kinds of information in the form of images or text on the screen of the display 180 based on a user input signal. The generated OSD signal may include various data including the user interface screen window of the image display apparatus 100, various menu screen windows, widgets, and icons. The generated OSD signal may also include a 2D object or a 3D object.

The OSD processor 340 may generate a pointer which can be displayed on the display, based on a pointing signal input from the remote controller 200. In particular, the pointer may be generated by a pointing signal processing device (not illustrated), and the OSD processor 340 may include the pointing signal generator. Of course, it is possible to provide the pointing signal processing device (not illustrated) separately from the OSD processor 340.

The frame rate converter (FRC) 350 may convert the frame rate of an input image. The FRC 350 may output frames without performing separate frame rate conversion.

The formatter 360 may change the format of an input image signal into an image signal for display on a display and output the changed image signal.

In particular, the formatter 360 may change the format of the image signal to correspond to the display panel.

Meanwhile, the formatter 360 may change the format of an image signal. For example, the format of the 3D image signal may be changed to any one format of various 3D formats such as a Side by Side format, a Top/Down format, a Frame Sequential format, an Interlaced format, a Checker Box format.

The processor 330 may control overall operations within the image display apparatus 100 or signal processing device 170.

For example, the processor 330 may control the tuner 110 to select (tuning) an RF broadcast corresponding to a channel selected by a user or a pre-stored channel.

The processor 330 may control the image display apparatus 100 according to a user command input through the user input interface 150 or an internal program.

The processor 330 may perform data transfer control with the network interface 135 or the external device interface 130.

The processor 330 may control operations of the demultiplexer 310 and the image processor 320 within the signal processing device 170.

An audio processor 370 in the signal processing device 170 may voice-process a demultiplexed voice signal. To this end, the audio processor 370 may include various decoders.

The audio processor 370 in the signal processing device 170 may perform processing such as adjustment of bass, treble, and volume.

The data processor (not illustrated) in the signal processing device 170 may perform data processing on a demultiplexed data signal. For example, in case in which the demultiplexed data signal is a coded data signal, the data processor (not illustrated) may decode the data signal. The coded data signal may be electronic program guide information including broadcast information such as a start time and end time of a broadcast program broadcast on each channel.

The block diagram of the signal processing device 170 illustrated in FIG. 3 is a block diagram for one embodiment of the present disclosure. Constituents of the block diagram may be integrated, added, or omitted according to the specifications of the signal processing device 170 which is implemented in reality.

In particular, the frame rate converter 350 and the formatter 360 may be separately provided in addition to the image processor 320.

FIG. 4A illustrates a method for controlling the remote controller of FIG. 2.

As illustrated in FIG. 4A(a), a pointer 205 corresponding to the remote controller 200 may be displayed on the display 180.

The user may move the remote controller 200 up and down, left and right (FIG. 4A(b)), or back and forth (FIG. 4A(c)) or rotate the same. The pointer 205 displayed on the display 180 of the image display apparatus corresponds to movement of the remote controller 200. As illustrated in the drawings, since the pointer 205 moves according to movement of the remote controller 200 in the 3D space, the remote controller 200 may be referred to as a spatial remote control or a 3D pointing device.

FIG. 4A(b) illustrates a case where the pointer 205 displayed on the display 180 of the image display apparatus moves to the left in case in which the user moves the remote controller 200 to the left.

Information about movement of the remote controller 200 sensed through a sensor of the remote controller 200 is transmitted to the image display apparatus. The image display apparatus may calculate coordinates of the pointer 205 based on the information about the movement of the remote controller 200. The image display apparatus may display the pointer 205 such that the pointer 205 corresponds to the calculated coordinates.

FIG. 4A(c) illustrates a case where the user moves the signal processing device 170 away from display 180 in a state where the user presses down a specific button in the remote controller 200. In this case, a selected area on the display 180 corresponding to the pointer 205 may be zoomed in and displayed with the size thereof increased. On the other hand, in case in which the user moves the remote controller 200 closer to the display 180, the selected area in the display 180 corresponding to the pointer 205 may be zoomed out and displayed with the size thereof reduced. Alternatively, the selected area may be zoomed out in case in which the remote controller 200 moves away from the display 180, and may be zoomed in in case in which the remote controller 200 moves closer to the display 180.

Vertical and lateral movement of the remote controller 200 may not be recognized while the specific button in the remote controller 200 is pressed down. That is, in case in which the remote controller 200 approaches or moves away from the display 180, vertical and lateral movements thereof may not be recognized, but back-and-forth movement thereof may be recognized. In case in which the specific button in the remote controller 200 is not pressed down, the pointer 205 only moves according to vertical and lateral movements of the remote controller 200.

The speed and direction of movement of the pointer 205 may correspond to the speed and direction of movement of the remote controller 200.

FIG. 4B is an internal block diagram illustrating the remote controller of FIG. 2.

Referring to the drawing, the remote controller 200 may include a wireless transceiver 425, a user input device 430, a sensor device 440, an output device 450, a power supply 460, a storage device 470, and a controller 480.

The wireless transceiver 425 transmits and receives signals to and from one of the image display apparatuses according to embodiments of the present disclosure described above. Hereinafter, one image display apparatus 100 according to one embodiment of the present disclosure will be described.

In this embodiment, the remote controller 200 may include an RF module 421 capable of transmitting and receiving signals to and from the image display apparatus 100 according to an RF communication standard. The remote controller 200 may further include an IR module 423 capable of transmitting and receiving signals to and from the image display apparatus 100 according to an IR communication standard.

In this embodiment, the remote controller 200 transmits a signal including information about movement of the remote controller 200 to the image display apparatus 100 via the RF module 421.

In addition, the remote controller 200 may receive a signal from the image display apparatus 100 via the RF module 421. In case in which necessary, the remote controller 200 may transmit commands related to power on/off, channel change, and volume change to the image display apparatus 100 via the IR module 423.

The user input device 430 may include a keypad, a button, a touchpad, or a touchscreen. The user may input a command related to the image display apparatus 100 with the remote controller 200 by manipulating the user input device 435. In case in which the user input device 435 includes a hard key button, the user may input a command related to the image display apparatus 100 with the remote controller 200 by pressing the hard key button. In case in which the user input device 435 includes a touchscreen, the user may input a command related to the image display apparatus 100 with the remote controller 200 by touching a soft key on the touchscreen. The user input device 430 may include various kinds of input means such as a scroll key and a jog key which are manipulatable by the user, but it should be noted that this embodiment does not limit the scope of the present disclosure.

The sensor device 440 may include a gyro sensor 441 or an acceleration sensor 443. The gyro sensor 441 may sense information about movement of the remote controller 200.

For example, the gyro sensor 441 may sense information about movement of the remote controller 200 with respect to the X, Y and Z axes. The acceleration sensor 443 may sense information about the movement speed of the remote controller 200. The sensor device 440 may further include a distance measurement sensor to sense a distance to the display 180.

The output device 450 may output an image signal or voice signal corresponding to manipulation of the user input device 435 or a signal transmitted from the image display apparatus 100. The user may recognize, via the output device 450, whether the user input device 435 is manipulated or the image display apparatus 100 is controlled.

For example, the output device 450 may include an LED module 451 to be turned on in case in which the user input device 35 is operated or signals are transmitted to and received from the image display apparatus 100 via the wireless transceiver 425, a vibration module 453 to generate vibration, a sound output module 455 to output sound, or a display module 457 to output an image.

The power supply 460 supplies power to the remote controller 200. In case in which the remote controller 200 does not move for a predetermined time, the power supply 460 may stop supplying power to save power. The power supply 460 may resume supply of power in case in which the predetermined key provided to the remote controller 200 is manipulated.

The storage device 470 may store various kinds of programs and application data necessary for control or operation of the remote controller 200. In case in which the remote controller 200 wirelessly transmits and receives signals to and from the image display apparatus 100 via the RF module 421, the remote controller 200 and the image display apparatus 100 may transmit and receive signals in a predetermined frequency band. The controller 480 of the remote controller 200 may store, in the storage device 470, information about, for example, a frequency band enabling wireless transmission and reception of signals to and from the image display apparatus 100 which is paired with the remote controller 200, and reference the same.

The controller 480 controls overall operation related to control of the remote controller 200. The controller 480 may transmit, via the wireless transceiver 425, a signal corresponding to manipulation of a predetermined key in the user input device 435 or a signal corresponding to movement of the remote controller 200 sensed by the sensor device 440 to the image display apparatus 100.

The user input interface 150 of the image display apparatus 100 may include a wireless transceiver 151 capable of wirelessly transmitting and receiving signals to and from the remote controller 200 and a coordinate calculator 415 capable of calculating coordinates of the pointer corresponding to operation of the remote controller 200.

The user input interface 150 may wirelessly transmit and receive signals to and from the remote controller 200 via an RF module 412. In addition, the user input interface 150 may receive, via an IR module 413, a signal transmitted from the remote controller 200 according to an IR communication standard.

The coordinate calculator 415 may calculate coordinates (x, y) of the pointer 205 to be displayed on the display 180, by correcting hand tremor or an error in a signal corresponding to operation of the remote controller 200 which is received via the wireless transceiver 151.

The transmitted signal of the remote controller 200 input to the image display apparatus 100 via the user input interface 150 is transmitted to the signal processing device 170 of the image display apparatus 100. The signal processing device 170 may determine information about an operation of the remote controller 200 or manipulation of a key from the signal transmitted from the remote controller 200, and control the image display apparatus 100 according to the information.

As another example, the remote controller 200 may calculate coordinates of the pointer corresponding to movement thereof and output the same to the user input interface 150 of the image display apparatus 100. In this case, the user input interface 150 of the image display apparatus 100 may transmit, to the signal processing device 170, information about the received coordinates of the pointer without separately correcting hand tremor or the error.

As another example, in contrast with the example of the drawing, the coordinate calculator 415 may be provided in the signal processing device 170 rather than in the user input interface 150.

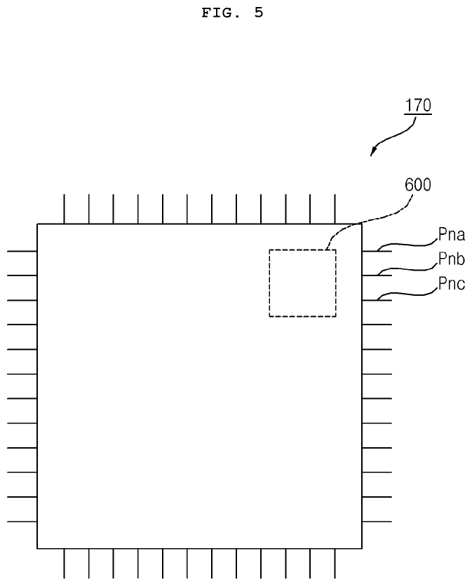

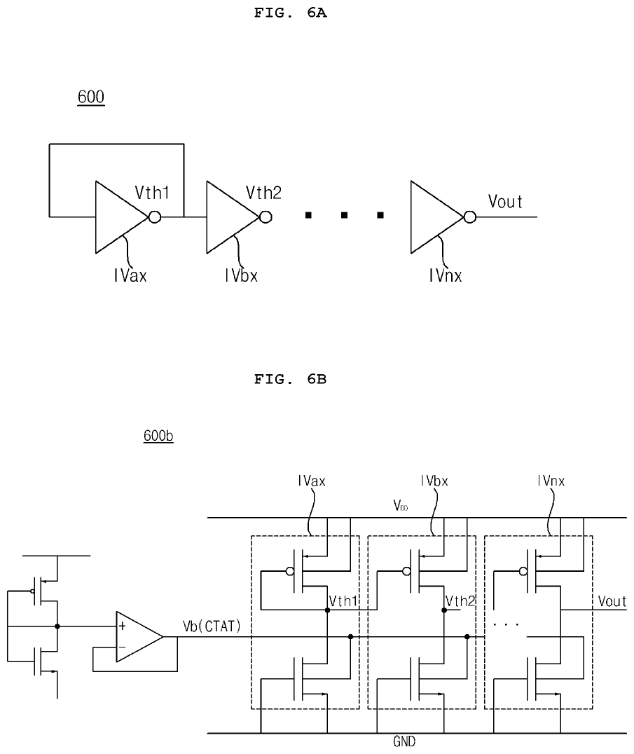

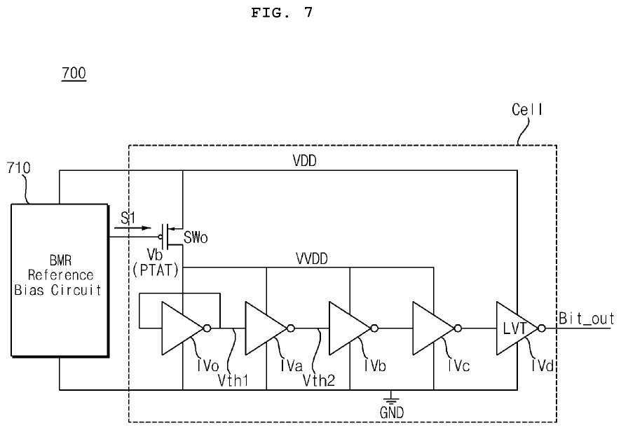

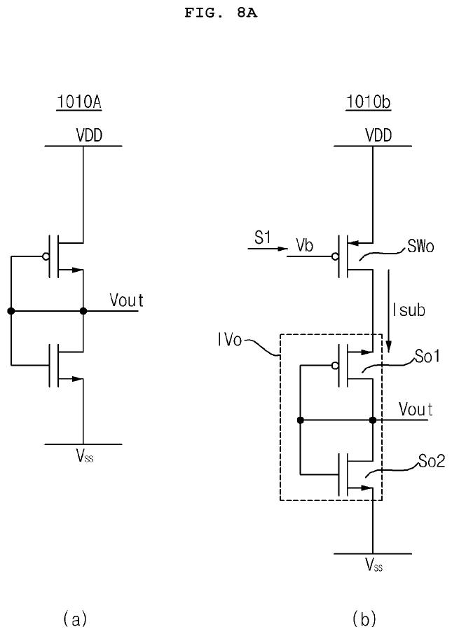

FIG. 5 is a diagram illustrating the appearance of a signal processing device according to an embodiment of the present disclosure.

Referring to the drawing, the signal processing device 170 in the form of a system-on-chip (SOC) may include a plurality of terminals to transmit or receive signals.

Meanwhile, the signal processing device 170 according to an embodiment of the present disclosure includes the PUF device 600, and some of the plurality of terminals may be used for operation of the PUF device 600.

For example, if the image display apparatus 100 is connected to the external server 300, the access request signal Scn may be output through a first terminal Pna of the signal processing device 170, and the access request signal Scn may be transmitted to the external server 300 via the network interface 135 and the like.

Meanwhile, the authentication request signal Srg received from the external server 300 may be received through the second terminal Pnab of the signal processing device 170.

In response, the encryption key data Srp may be output through a third terminal Pnc of the signal processing device 170, and the encryption key data Srp may be transmitted to the external server 300 via the network interface 135 and the like.

Meanwhile, in case in which authentication based on the encryption key data Srp is completed by the external server 300, the signal processing device 170 may receive information or video data Sst.

Accordingly, information or video data Sst based on the encryption key data Srp may be displayed on the display 180.

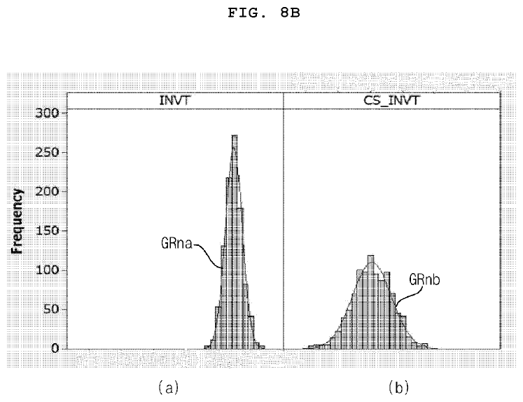

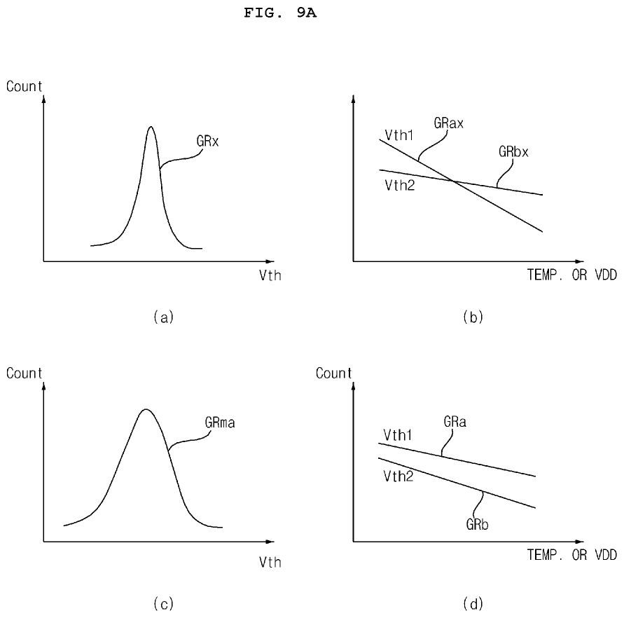

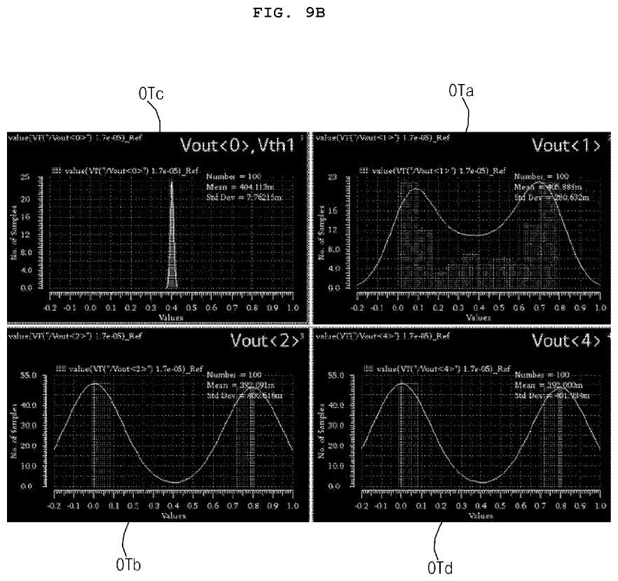

FIGS. 6A and 6B are diagrams illustrating various examples of a PUF device associated with the present disclosure.

First, FIG. 6A is a diagram illustrating an example of a PUF device 600 associated with the present disclosure.

The PUF device 600 associated with the present disclosure may include a plurality of inverters IVaz to IVnx.

The PUF device 600 may output a random number by amplifying a minute deviation between elements based on threshold voltages Vth1, Vth2, . . . etc., of the respective inverters IVaz to IVnx.

However, in the PUF device 600 of FIG. 6A, a bit may be easily flipped due to an operating voltage change or a temperature change, such that a bit error occurs.

Next, FIG. 6B is a diagram illustrating a PUF device 600b associated with the present disclosure.

The PUF device 600b of FIG. 6B is a more specific embodiment of the PUF device 600 of FIG. 6A, and the PUF device 600b includes a plurality of inverters IVaz to IVnx which are driven by a driving voltage VDD.

However, in the PUF device 600b of FIG. 6B, a bit may be easily flipped due to an operating voltage change or a temperature change, such that a bit error occurs.

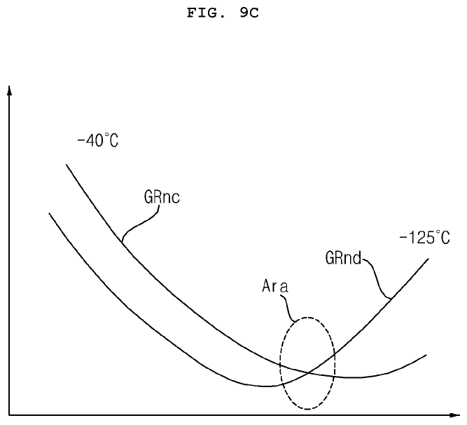

Accordingly, the present disclosure proposes a PUF device that is robust to operating power change and reduces bit errors. Particularly, the present disclosure proposes a PUF device in which headroom is reduced by using a current starved inverter, and bit errors may be reduced by amplifying symmetric switching voltages. In addition, the present disclosure proposes a PUF device capable of outputting the same bit even in case in which the external environment changes, which will be described below with reference to FIG. 7 and the following figures.

FIG. 7 is an example of a circuit diagram illustrating a PUF device according to an embodiment of the present disclosure.

Referring to the drawing, a PUF device 700 according to an embodiment of the present disclosure includes a bias circuit 710 configured to output a first signal S1 based on a first operating power VDD; a power source SWo configured to output a second operating power VVDD based on the first signal S1 and the first operating power VDD; and a plurality of inverters IVo to IVd configured to perform an amplification operation based on the second operating power VVDD from the power source SWo.

Accordingly, the PUF device 700 that is robust to operating power change and reduces bit errors may be implemented. In addition, the PUF device 700 which is even robust to temperature change may be implemented. Particularly, the same bit may be output constantly even in case in which the external environment changes.

Meanwhile, the plurality of inverter IVo to IVd are sequentially arranged in a multi-stage, in which a first inverter IVo among the plurality of inverters IVo to IVd may output a signal by bypassing an input signal, and inverters IVa to IVd after the first inverter IVo may output output signals by amplifying the input signal. Accordingly, the PUF device 700 that is robust to operating power change and temperature change and reduces bit errors may be implemented.

Meanwhile, the first inverter IVo may include a current starved inverter. Accordingly, the PUF device 700 may be implemented in which headroom is reduced by using the current starved inverter, and bit errors are reduced by amplifying symmetric switching voltages.

Meanwhile, by using the current starved inverter as the first inverter IVo, deviation distribution between a first threshold voltage Vth1 of the first inverter IVo and a threshold voltage Vth2 of a second inverter IVa may increase.

Meanwhile, the first inverter IVo preferably operates in a sub-threshold region in order to minimize power consumption by limiting the headroom in the inverters.

Meanwhile, by using the sub-threshold region, deviation distribution of initial threshold voltages may increase, and power consumption may be significantly reduced by driving at a low current of a few uA and reducing the headroom of an inverter voltage. In addition, by using the sub-threshold region, predictability of external attacks is lowered.

Meanwhile, the PUF device 700 according to an embodiment of the present disclosure are not subjected to physical deformation or do not use a non-volatile memory, and thus has strong resistance to external hacking.

Meanwhile, all the plurality of inverters IVo to IVd may also be the current starved inverters. Accordingly, the deviation distribution between the first threshold voltage Vth1 of the first inverter IVo and the threshold voltage Vth2 of the second inverter IVa may increase.

Meanwhile, the plurality of inverters IVo to IVd preferably operate in the sub-threshold region in order to minimize power consumption by limiting the headroom in the inverters.

Meanwhile, the PUF device 700 according to an embodiment of the present disclosure are not subjected to physical deformation or do not use a non-volatile memory, and thus has strong resistance to external hacking.

Meanwhile, the power source SWo may include a MOSFET device in which the first signal S1 is input to a gate terminal, the first operating power VDD is input to a source terminal, and the second operating power VVDD is output through a drain terminal.

In this case, the MOSFET device may be a P-type MOSFET device, as illustrated in the drawing. Meanwhile, the MOSFET device may also be an N-type MOSFET device.

That is, as an output terminal of the bias circuit 710 is connected to the gate terminal of the MOSFET device SWo, the first signal S1 may be input to the gate terminal and the first operating power VDD may be input to the source terminal, and as power terminals of the plurality of inverters IVo to IVd are connected to the drain terminal, the second operating power VVDD output through the drain terminal may be supplied to the plurality of inverters IVo to IVd.

In this case, a level of the second operating power VVDD is preferably lower than a level of the first operating power VDD. For example, if the first operating power VDD is approximately 0.8 V, the second operating power VVDD may be approximately 0.4 V, which is half the first operating power VDD.

Accordingly, the PUF device 700 that is robust to operating power change and temperature change and reduces bit errors may be implemented.

Meanwhile, the MOSFET device SWo, which operates as a power source, and the plurality of inverters IVo to IVd constitute one cell, and one MOSFET device SWo and the plurality of inverters IVo to IVd may be disposed in each of a plurality of cells.

Meanwhile, based on the first operating power VDD, the bias circuit 710 may supply the first signal S1 having a current at a predetermined level or a voltage at a predetermined level.

In response to the first signal S1, a voltage Vb is supplied to the gate terminal of the MOSFET device SWo, such that the plurality of inverters IVo to IVd including the first inverter IVo may be drive in the sub-threshold region.

Meanwhile, while having Proportional To Absolute Temperature (PTAT) characteristics, the voltage Vb preferably has specific temperature coefficient characteristics with a minimum bit error rate (BER).

Meanwhile, the bias circuit 710 preferably has an appropriate temperature coefficient, so as to supply power that is insensitive to a change in external power and is less sensitive to temperature.

Accordingly, the PUF device 700 that is robust to operating power change and temperature change and reduces bit errors may be implemented.

Meanwhile, elements in the plurality of inverters IVo to IVd preferably have a minimum size that is guaranteed in the process, so as to induce a maximum mismatch distribution.

Meanwhile, as the plurality of inverters IVo to IVd operate at the second operating power VVDD which is lower than the first operating power VDD supplied from an external source, such that an inverter IVd arranged at the last stage among the plurality of inverters IVo to IVd preferably has a low logic threshold voltage (low logic Vth).

That is, a last inverter IVd among the plurality of inverters IVo to IVd preferably has a lower threshold voltage than the other inverters. Accordingly, output is not biased to any one side.

Meanwhile, the plurality of inverters IVo to IVd may generate and output random numbers by performing an amplification operation. Accordingly, the PUF device 700 that is robust to operating power change and temperature change and reduces bit errors may be implemented.

Meanwhile, in case in which a temperature changes or a level of the first operating power VDD changes, a level of the first threshold voltage Vth1 of the first inverter IVo among the plurality of inverters IVo to IVd is greater than a level of the second threshold voltage Vth2 of the second inverter IVa among the plurality of inverters IVo to IVd. Accordingly, the PUF device 700 that is robust to operating power change and temperature change and reduces bit errors may be implemented.

FIGS. 8A to 16D are diagrams referred to in the description of FIG. 7.

First, FIG. 8A is a diagram illustrating an inverter in the PUF device 600b of FIG. 6B and the first inverter IVo in the PUF device 700 of FIG. 7.

In (a) of FIG. 8A, an inverter 1010A in the PUF device 600b of FIG. 6B includes a high-side switching element and a low-side switching element and operates at the first operating power VDD.

In (b) of FIG. 8A, the first inverter IVo in the PUF device 700 of FIG. 7 is a current starved inverter and operates based on the second operating power VVDD output from the drain terminal of the MOSFET device SWo.

In case in which a level of the first operating power VDD supplied from an external source changes due to the external environment and the like, a bit is flipped easily, causing a bit error as illustrated in (a) of FIG. 8A, but the second operating power VVDD at a constant level is output from the drain terminal of the MOSFET device SWo as illustrated in (b) of FIG. 8A, such that the PUF device may be robust to operating power change and temperature change, and bit errors may be reduced.

FIG. 8B is a diagram illustrating logic Vth distribution of each inverter of FIG. 8A.

Referring to the drawing, (a) of FIG. 8B is a graph GRna showing logic Vth distribution of the inverter 1010A of (a) of FIG. 8A, and (b) of FIG. 8B is a graph GRnb showing logic Vth distribution of the current starved inverter of (b) of FIG. 8A.

In comparison of the graph GRna of (a) of FIG. 8B with the graph GRnb of (b) of FIG. 8B, it can be seen that a standard deviation in the graph GRna of (a) of FIG. 8B is greater than a standard deviation in the graph GRnb of (b) of FIG. 8B.

For example, the standard deviation in the graph GRna of (a) of FIG. 8B may be about 2.3 times the standard deviation in the graph GRnb of (b) of FIG. 8B.

Accordingly, in the PUF device 700 according to an embodiment of the present disclosure, deviation distribution may increase even with a low operating power, and as a result, a bit error may be reduced.

In FIG. 9A, (a) illustrates a graph GRx showing logic Vth distribution of the inverter 1010A of the PUF device 600b of FIG. 6B.

In FIG. 9A, (b) illustrates a change graph GRax of the first threshold voltage Vth1 of the first inverter IVax and a change graph GRbx of the second threshold voltage Vth2 of the second inverter IVbx in the PUF device 600b of FIG. 6B.

Referring to the drawing, the first threshold voltage Vth1 of the first inverter IVax is greater than the second threshold voltage Vth2 of the second inverter IVbx at a low driving voltage or low temperature, but in case in which the driving voltage or temperature increases, the second threshold voltage Vth2 of the second inverter IVbx becomes greater than the first threshold voltage Vth1 of the first inverter IVax.

In FIG. 9A, (c) illustrates a graph GRma showing logic Vth distribution of the current starved inverter of the PUF device 700 of FIG. 7.

In comparison of the graph GRx of (a) of FIG. 9A with the graph GRma of (c) of FIG. 9A, it can be seen that a standard deviation in the graph GRma of (c) of FIG. 9A is greater than a standard deviation in the graph GRx of (a) of FIG. 9A.

In FIG. 9A, (d) illustrates a change graph GRa of the first threshold voltage Vth1 of the first inverter IVo and a change graph GRb of the second threshold voltage Vth2 of the second inverter IVa in the PUF device 700 of FIG. 7.

Referring to the drawing, the first threshold voltage Vth1 of the first inverter IVax is greater than the second threshold voltage Vth2 of the second inverter IVbx at a low driving voltage or low temperature, and even in case in which the driving voltage or temperature increases, the first threshold voltage Vth1 of the first inverter IVax is greater than the second threshold voltage Vth2 of the second inverter IVbx.

That is, even in case in which the temperature changes or the level of the first operating power VDD changes, a level of the first threshold voltage Vth1 of the first inverter IVo is greater than a level of the second threshold voltage Vth2 of the second inverter Iva among the plurality of inverters IVo to IVd.

Accordingly, the PUF device 700 that is robust to operating power change and temperature change and reduces bit errors may be implemented.

FIG. 9B is a diagram illustrating an output of each inverter of the PUF device 700 of FIG. 7.

Referring to the drawing, (a) of FIG. 9B illustrates a graph OTc showing an output of the first inverter IVo, (b) of FIG. 9B illustrates a graph OTa showing an output of the second inverter IVa, (c) of FIG. 9B illustrates a graph OTb showing an output of a third inverter IVb, and (d) of FIG. 9B illustrates a graph OTd showing an output of a last inverter IVd.

It can be seen that, from (a) of FIG. 9B to (d) of FIG. 9B, output values are separated in the order of stages.

That is, while passing through the respective stages, the plurality of inverters IVo to IVd separate output values.

FIG. 9C is a diagram illustrating a graph associated with a voltage of the first signal S1 output from the bias circuit 710.

Referring to the drawing, a first graph GRnc shows a temperature coefficient at −40° C., and a second graph GRnd shows a temperature coefficient at −125° C.

The bias circuit 710 preferably outputs the first signal S1 having an optimal temperature coefficient, such as Ara, so as to supply a current that is insensitive to a change in external power and is less sensitive to temperature.

For example, an optimal temperature coefficient of a voltage Vb of the first signal S1 may be 1000 ppm/° C.

Accordingly, the PUF device 700 that is robust to operating power change and temperature change and reduces bit errors may be implemented.

Meanwhile, the PUF device 700 according to another embodiment of the present disclosure includes a MOSFET device SWo in which a first signal S1 is input to a gate terminal, a first operating power VDD is input to a source terminal, and a second operating power VVDD is output through a drain terminal, and a plurality of inverters IVo to IVd configured to perform an amplification operation based on the second operating power VVDD from the MOSFET device SWo.

The plurality of inverters IVo to IVd are sequentially arranged in a multi-stage, in which a first inverter IVo among the plurality of inverters IVo to IVd may output a signal by bypassing an input signal, and inverters IVa to IVd after the first inverter IVo may output output signals by amplifying the input signal.

Accordingly, the PUF device 700 that is robust to operating power change and reduces bit errors may be implemented. Further, the PUF device 700 which is even robust to temperature change may be implemented. Particularly, the same bit may be output constantly even in case in which the external environment changes.

Meanwhile, even in case in which the level of the first operating power VDD changes, a current or voltage of the first signal S1 remains at a constant level. Accordingly, the PUF device 700 that is robust to operating power change and reduces bit errors may be implemented.

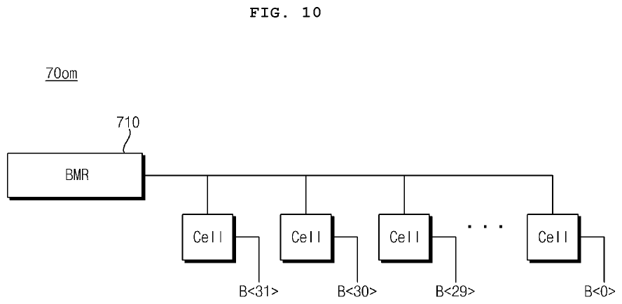

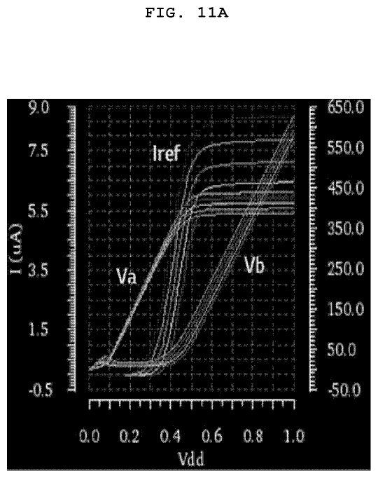

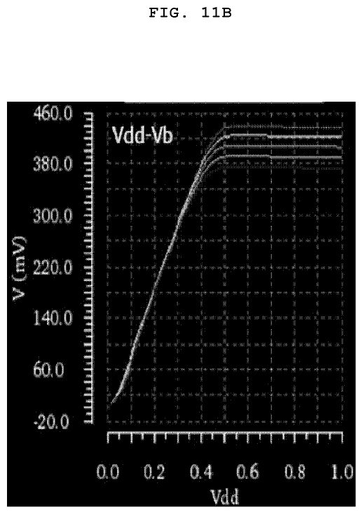

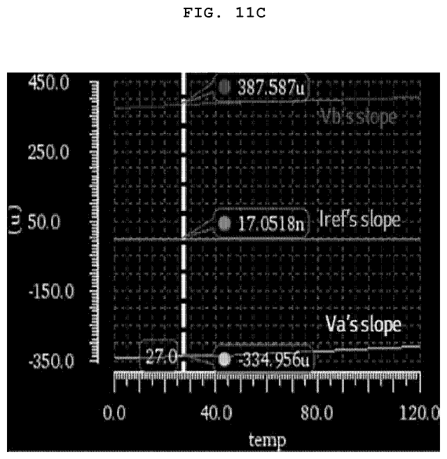

FIG. 10 is a diagram illustrating a PUF device 700m according to another embodiment of the present disclosure.

Referring to the drawing, the PUF device 700m according to another embodiment of the present disclosure may include a bias circuit 710 configured to output a first signal S1 based on a first operating power VDD, and a plurality of cells.

Further, as illustrated in FIG. 7, each cell may include a power source SWo configured to output a second operating power VVDD based on the first signal S1 and the first operating power VDD, and a plurality of inverters IVo to IVd configured to perform an amplification operation based on the second operating power VVDD from the power source SWo. Accordingly, a plurality of bits may be output with a reduced bit error.

Meanwhile, in the PUF device 700m according to an embodiment of the present disclosure, the first operating power VDD may be about 0.8 V, a current reference value Iref is about 6 uA, and a voltage Vb of the first signal S1 may be about 0.4 V.

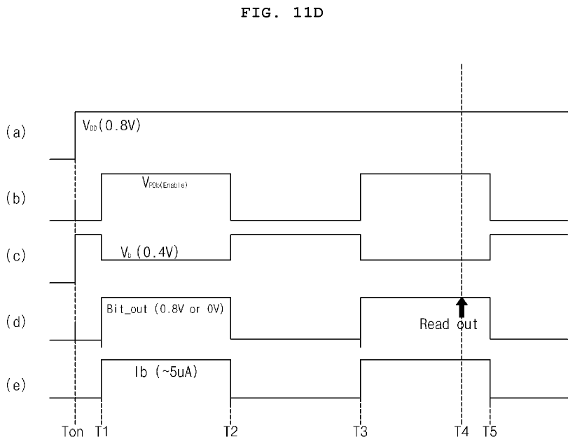

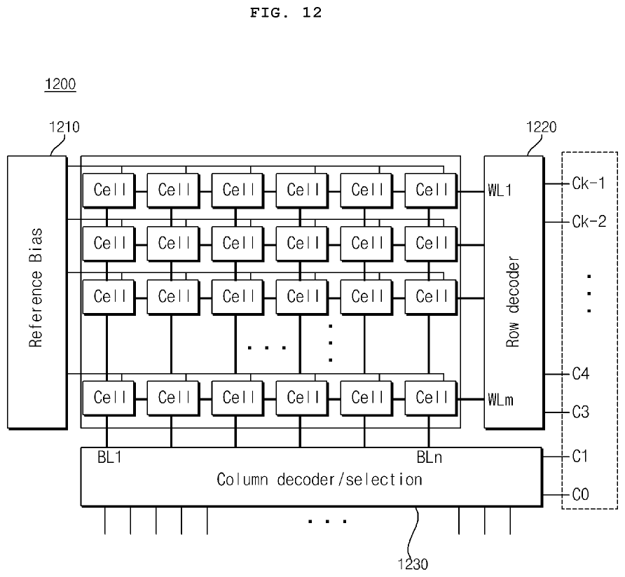

FIG. 11A is a diagram illustrating the current reference value Iref, the voltage Vb of the first signal S1, and the like in the PUF device 700m according to an embodiment of the present disclosure.

FIG. 11B is a diagram illustrating a relationship between the first operating power VDD and the voltage Vb of the first signal S1.

The first operating power VDD supplied from an external source should be considered with a variation of about ±10%, such that stable and constant voltage VDD-Vb and current Iref should be guaranteed considering the case where the first operating power VDD is 0.6 V or higher.

FIG. 11C is a diagram illustrating changes in Va, Iref, and Va according to a temperature change.

FIG. 11D is a timing diagram explaining a bit output in response to the supply of the first operating power VDD.

Referring to the drawing, (a) of FIG. 11D illustrates a waveform of the first operating power VDD, (b) of FIG. 11D illustrates an operating waveform of the bias circuit 710, (c) of FIG. 11D illustrates a waveform of the voltage Vb of the first signal S1, (d) of FIG. 11D illustrates an output waveform of the last inverter IVd, and (e) of FIG. 11D illustrates a waveform of the current Ib of the first signal S1.

The first operating power VDD is turned on and supplied at a time Ton. Accordingly, the bias circuit 710 is turned on and operates at a time T1 after the time Ton, such that the first signal S1 is output.

A voltage level of the first signal S1, which is output from a time T1, may decrease from a high level to a low level. In this case, the low level may be 0.4 V.

Meanwhile, from the time T1, an output level of the last inverter IVd and a level of the current Ib of the first signal S1 may be high levels, rather than low levels.

The bias circuit 710 is turned off at a time T2 after the time T1, such that a voltage level of the first signal S1, which is output from a time 21, may be a high level, and the output level of the last inverter IVd and the level of the current Ib of the first signal S1 may be low levels.

The bias circuit 710 is turned on again and operates at a time T3, in which the voltage level of the first signal S1 may be a low level, and the output level of the last inverter IVd and the level of the current Ib of the first signal S1 may be high levels.

Then, at a time T4 after the time T3, a high level which is the output level of the last inverter IVd may be read out.

Meanwhile, the bias circuit 710 is turned off at a time T5, such that the voltage level of the first signal S1, which is output from the time 21, may be a high level, and the output level of the last inverter IVd and the level of the current Ib of the first signal S1 may be low levels.

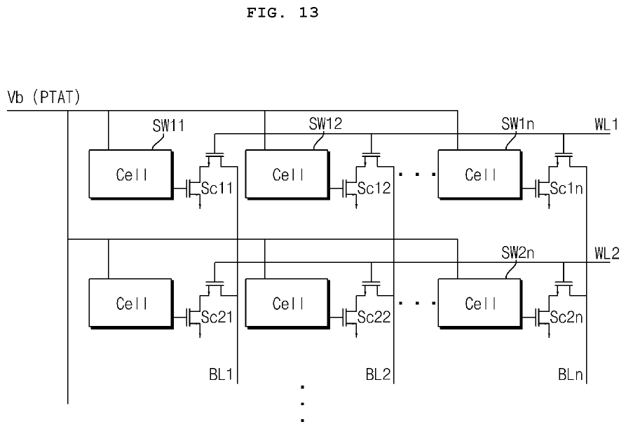

FIG. 12 is an example of a circuit diagram of a PUF according to further another embodiment of the present disclosure.

Referring to the drawing, a PUF device 1200 according to further another embodiment of the present disclosure includes a plurality of cells arranged in a matrix form, a first decoder 1220 configured to supply a same signal to cells in a same row among the plurality of cells, a second decoder 1230 configured to supply a same signal to cells in a same column among the plurality of cells, and a bias circuit 710 configured to output a first signal S1 based on a first operating power VDD.

Each of the plurality of cells includes a power source SWo configured to output a second operating power VVDD based on the first signal S1 and the first operating power VDD, and a plurality of inverters IVo to IVd configured to perform an amplification operation based on the second operating power VVDD from the power source SWo.

Accordingly, the PUF device 700 that is robust to operating power change and reduces bit errors may be implemented. In addition, the PUF device 700 that is even robust to temperature change may be implemented. Particularly, the same bit may be output constantly even in case in which the external environment changes.

Meanwhile, a voltage Vb of the first signal S1 of the bias circuit 710 may be applied to all the cells.

Meanwhile, the power source SWo may be shared among the cells in the same row.

Meanwhile, a desired number of challenges increases by using row and column decoders 1220 and 1230, and the number of rows and columns increases corresponding thereto.

Particularly, if there is “n” number of challenge inputs to the second decoder 1230 which is the row decoder, the number of rows preferably increases by 2n.

Meanwhile, most of the columns are required to output encryption key data having a long bit-length, such that it is preferable to configure a circuit capable of selecting a specific group so as to output a corresponding bit length to the first decoder 1220 which is the column decoder.

The matrix array is useful for an authentication system adopting a challenge-response pair (CRP) method.

Meanwhile, a PUF device 1200 according to further another embodiment of the present disclosure generates Response values that change continuously according to Challenges, and uses the values as temporary keys.

As the number of Challenges increases or as the number of Challenge-Response Pairs (CRPs) increases, a robust PUF device may be provided which is useful for an authentication server 300.

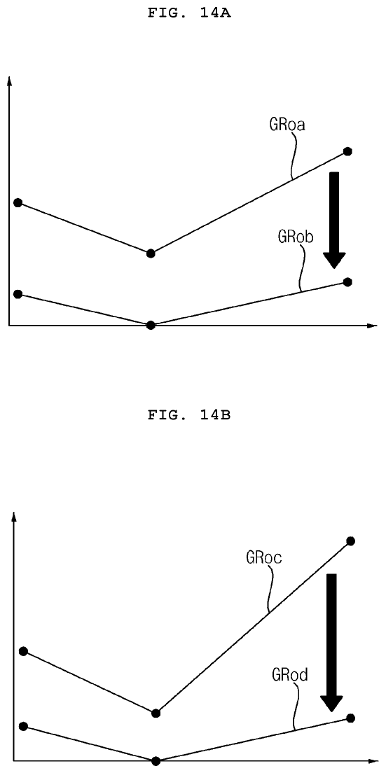

FIG. 13 is a diagram referred to in the description of FIG. 12.

Referring to the drawing, in the case where the cells of FIG. 12 are arranged in a matrix form, bit data of a specific cell may be output by inputting desired Word Line (WL) and Bit Line (BL) addresses.

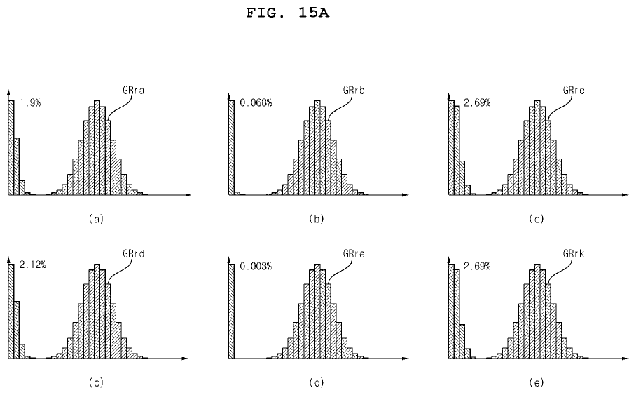

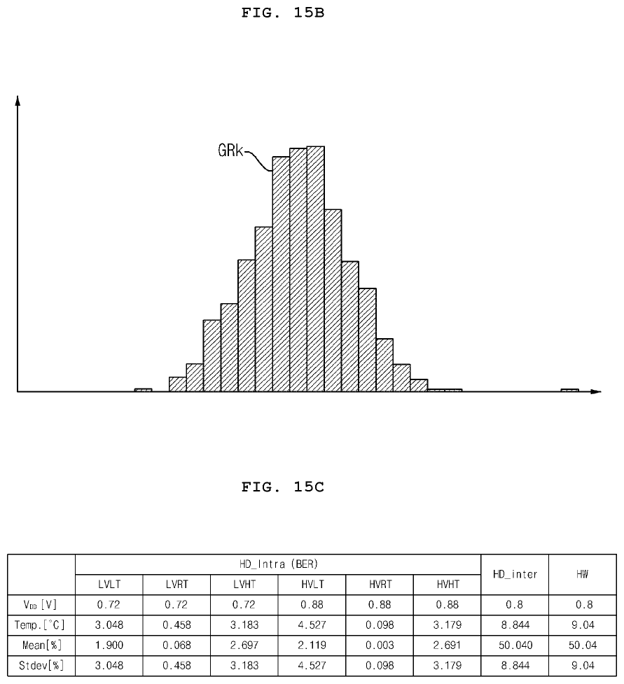

FIG. 14A is a diagram illustrating bit errors of the inverter of FIG. 6B and the inverter of FIG. 7 according to a change in low level of the first operating power VDD.

Referring to the drawing, a graph GRoa shows a bit error according to a temperature change in the inverter 1010A of FIG. 6B in case in which the first operating power VDD is at a low level of −10%.

Based on the graph GRoa, it can be seen that as the temperature increases, a bit error increases significantly.

Meanwhile, a graph GRob shows a bit error according to a temperature change in the first inverter IVO which is the current starved inverter of FIG. 7 in case in which the first operating power VDD is at a low level of −10%.

Based on the graph GRob, it can be seen that as the temperature increases, a bit error increases slightly, but is considerably reduced compared to the graph GRoa.

That is, in the PUF device 700 of the present disclosure, even in case in which the first operating power VDD is reduced and temperature changes, the bit error is considerably reduced.

FIG. 14B is a diagram illustrating bit errors of the inverter of FIG. 6B and the inverter of FIG. 7 according to a change in high level of the first operating power VDD.

Referring to the drawing, a graph GRoc shows a bit error according to a temperature change in the inverter 1010A of FIG. 6B in case in which the first operating power VDD is at a high level of +10%.

Based on the graph GRoa, it can be seen that as the temperature increases, a bit error increases significantly.

Particularly, in comparison with the graph GRoa of FIG. 14A, in case in which the first operating power VDD increases, the bit error further increases as the temperature increases, compared to the case where the first operating power VDD decreases.

Meanwhile, a graph GRod shows a bit error according to a temperature change in the first inverter IVO which is the current starved inverter of FIG. 7 in case in which the first operating power VDD is at a high level of +10%.

Based on the graph GRod, it can be seen that as the temperature increases, a bit error increases slightly, but is considerably reduced compared to the graph GRoc.

That is, in the PUF device 700 of the present disclosure, even in case in which the first operating power VDD increases and temperature changes, the bit error is considerably reduced.

FIG. 15A is a diagram illustrating a result of inter-Hamming-distance & Hamming-weight for the PUF device 700m of FIG. 10.

Referring to the drawing, by arranging the plurality of cells in the PUF device 700m of FIG. 10 for a 32-bit output, and by performing Monte-Carlo simulation, results of graphs GRra to GRRk in the drawing may be obtained.

Particularly, an excellent result of the BER of 2.7% or less and the inter-Hamming-distance & Hamming-weight of 50% may be obtained.

That is, the PUF device 700 of the present disclosure, which is robust to level change of the first operating power VDD and even to temperature change, may be implemented. Particularly, the same bit may be output constantly even in case in which the external environment changes.

FIG. 15B is a graph showing a result of Normalized Hamming Weight, and FIG. 15C is a table showing a result of intra-Hamming-distance & Hamming-weight and a result of inter-Hamming-distance & Hamming-weight.

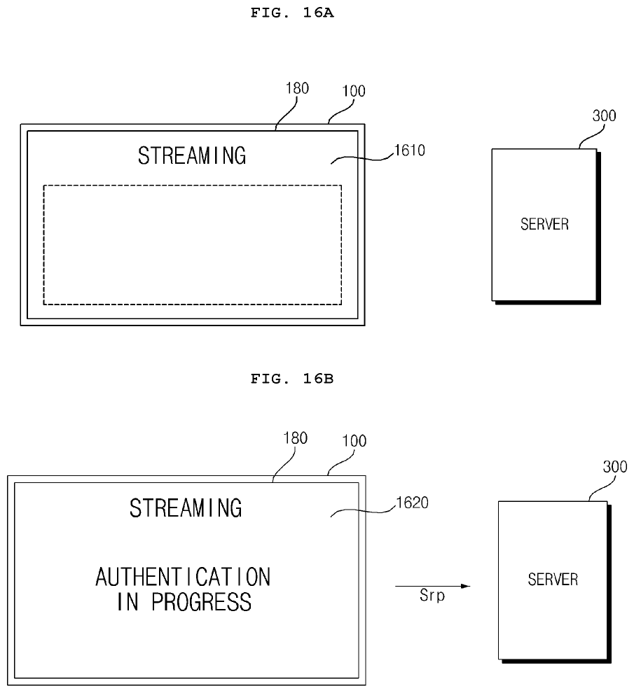

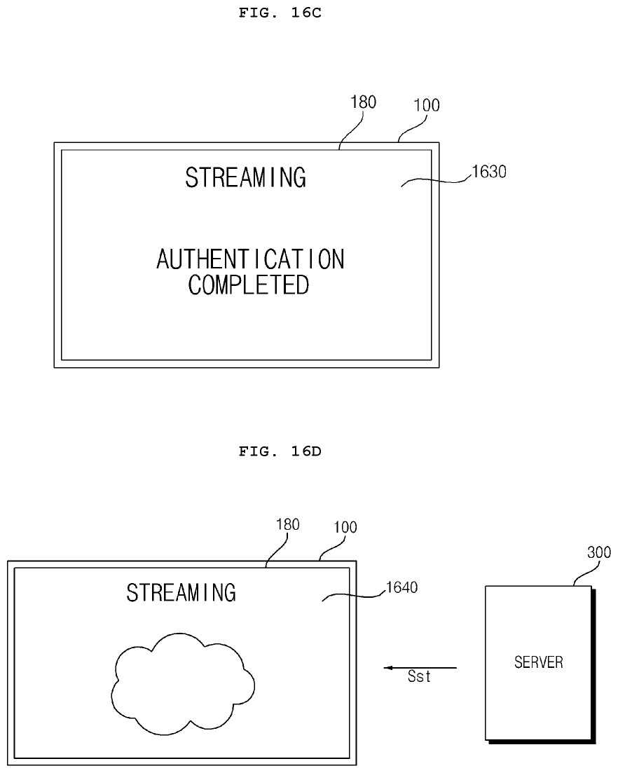

FIGS. 16A to 16D are diagrams referred to in the description of the operation of FIG. 1.

First, FIG. 16A is a diagram illustrating an example of displaying a video stream start screen 1610 on the image display apparatus 100.

For example, in case in which the image display apparatus 100 is connected to the external server 300 to provide a video streaming service, the image display apparatus 100 may transmit the access request signal Scn to the external server 300, and the external server 300 may transmit the authentication request signal Srg to the image display apparatus 100.

Next, FIG. 16B is a diagram illustrating an example of displaying a screen 1620, indicating that authentication is in progress, on the image display apparatus 100.

Upon receiving the authentication request signal Srg from the server 300, the image display apparatus 100 may transmit the encryption key data Srp to the external server 300. Accordingly, the screen 1620 indicating that authentication is in progress may be displayed on the display 180 of the image display apparatus 100.

Then, FIG. 16C is a diagram illustrating an example of displaying a screen 1630, indicating that authentication is completed, on the image display apparatus 100.

Upon completing authentication based on the encryption key data Srp, the server 300 may transmit information, indicating that authentication is completed, to the image display apparatus 100.

Accordingly, the screen 1630 indicating that authentication is completed may be displayed on the display 180 of the image display apparatus 100.

Subsequently, FIG. 16D is a diagram illustrating an example of displaying a video streaming screen 1640 on the image display apparatus 100, after authentication is completed.

In case in which authentication is completed by the server 300, the image display apparatus 100 may receive video stream data and may perform signal processing thereon to control the video streaming screen 1640 to be displayed on the display 180.

Meanwhile, the transmitted encryption key data Srp in FIG. 16B and the like is data to which a physically unclonable function (PUF) based on hardware rather than software is applied, and is preferably data output by the PUF device 600 of FIG. 7 or the PUF device 1200 of FIG. 12. Accordingly, duplication is impossible, and separate error correction is not required even in case in which external temperature or power voltage changes.

It will be apparent that, although the preferred embodiments have been illustrated and described above, the present disclosure is not limited to the above-described specific embodiments, and various modifications and variations can be made by those skilled in the art without departing from the gist of the appended claims. Thus, it is intended that the modifications and variations should not be understood independently of the technical spirit or prospect of the present disclosure.

1. A physically unclonable function (PUF) device comprising:
a bias circuit configured to output a first signal based on a first operating power;
a power source configured to output a second operating power based on the first signal and the first operating power; and
a plurality of inverters configured to perform an amplification operation based on the second operating power from the power source.

2. The PUF device of claim 1, wherein the plurality of inverters are sequentially arranged in a multi-stage,
wherein a first inverter among the plurality of inverters outputs a signal by bypassing an input signal, and inverters arranged in stages after the first inverter output signals by amplifying the input signal.

3. The PUF device of claim 2, wherein the first inverter comprises a current starved inverter.

4. The PUF device of claim 1, wherein the power source comprises a MOSFET device in which the first signal is input to a gate terminal, the first operating power is input to a source terminal, and the second operating power is output through a drain terminal.

5. The PUF device of claim 1, wherein, based on the first operating power, the bias circuit supplies the first signal having a current at a predetermined level or a voltage at a predetermined level.

6. The PUF device of claim 1, wherein in case in which temperature changes or a level of the first operating power changes, a level of a first threshold voltage of the first inverter among the plurality of inverters is greater than a level of a second threshold voltage of a second inverter among the plurality of inverters.

7. The PUF device of claim 1, wherein the power source and the plurality of inverters constitute one cell and comprise the bias circuit and a plurality of cells.

8. The PUF device of claim 1, wherein in response to the amplification operation, the plurality of inverters generate and output random numbers.

9. A physically unclonable function (PUF) device comprising:
a MOSFET device in which a first signal is input to a gate terminal, a first operating power is input to a source terminal, and a second operating power is output through a drain terminal; and
a plurality of inverters configured to perform an amplification operation based on the second operating power from the MOSFET device,
wherein the plurality of inverters are sequentially arranged in a multi-stage,
wherein a first inverter among the plurality of inverters outputs a signal by bypassing an input signal, and inverters arranged in stages after the first inverter output signals by amplifying the input signal.

10. The PUF device of claim 9, wherein even in case in which a level of the first operating power changes, a current or voltage of the first signal is at a constant level.

11. The PUF device of claim 9, wherein a level of a first threshold voltage of the first inverter among the plurality of inverters is constantly greater than a level of a second threshold voltage of a second inverter among the plurality of inverters.

12. A physically unclonable function (PUF) device comprising:
a plurality of cells arranged in a matrix form;
a first decoder configured to supply a same signal to cells in a same row among the plurality of cells;
a second decoder configured to supply a same signal to cells in a same column among the plurality of cells; and
a bias circuit configured to output a first signal based on a first operating power, wherein each of the plurality of cells comprises:
a power source configured to output a second operating power based on the first signal and the first operating power; and
a plurality of inverters configured to perform an amplification operation based on the second operating power from the power source.

13. The PUF device of claim 12, wherein the plurality of inverters are sequentially arranged in a multi-stage,
wherein a first inverter among the plurality of inverters outputs a signal by bypassing an input signal, and inverters arranged in stages after the first inverter output signals by amplifying the input signal.

14. The PUF device of claim 13, wherein the first inverter comprises a current starved inverter.

15. The PUF device of claim 12, wherein the power source comprises a MOSFET device in which the first signal is input to a gate terminal, the first operating power is input to a source terminal, and the second operating power is output through a drain terminal.

16. The PUF device of claim 12, wherein, based on the first operating power, the bias circuit supplies the first signal having a current at a predetermined level or a voltage at a predetermined level.

17. The PUF device of claim 12, wherein in case in which temperature changes or a level of the first operating power changes, a level of a first threshold voltage of the first inverter among the plurality of inverters is greater than a level of a second threshold voltage of a second inverter among the plurality of inverters.

18. A signal processing device comprising a physically unclonable function (PUF) device,
wherein the PUF device comprising:
a bias circuit configured to output a first signal based on a first operating power;
a power source configured to output a second operating power based on the first signal and the first operating power; and
a plurality of inverters configured to perform an amplification operation based on the second operating power from the power source.

19. An image display apparatus comprising:
a display; and
the signal processing device of claim 18.

20. The signal processing device of claim 18, wherein the plurality of inverters are sequentially arranged in a multi-stage,
wherein a first inverter among the plurality of inverters outputs a signal by bypassing an input signal, and inverters arranged in stages after the first inverter output signals by amplifying the input signal.
